(19) United States
(12) Patent Application Publication
(10) Pub. No.: US 2004/0121135 A1
(43) Pub. Date: Jun. 24, 2004

(54) ULTRA WHITE WIPE

(75) Inventors: Jeffrey Hurley, Bartlett, TN (US); John Erspamer, Lakeland, TN (US)

Correspondence Address: DARBY & DARBY P.C., P. O. BOX 5257, NEW YORK, NY, 10150-5257, US

(73) Assignee: BKI HOLDING CORPORATION, Wilmington, DE (US)

(21) Appl. No.: 10/707,598

(22) Filed: Dec. 23, 2003

Related U.S. Application Data
(63) Continuation of application No. PCT/US03/11519, filed on Apr. 14, 2003.
(60) Provisional application No. 60/372,254, filed on Apr. 12, 2002.
(60) Provisional application No. 60/441,004, filed on Jan. 17, 2003.

(51) Int. Cl. B32B 9/00

(52) U.S. Cl. 428/221

(57) ABSTRACT

The present invention relates to ultra white wipe material, ultra white nonwoven material, and a process for making the materials, where the materials have superior whiteness, brightness, opacity and aesthetic optical value. Specifically, the materials are comprised of bulk fibers, a binder, and bicomponent fibers including a delustrant and optical brightener.

### RELATED APPLICATION DATA

This application claims priority under 35 U.S.C. § 119 from U.S. provisional application serial No. 60/372,254 filed Apr. 12, 2002; and U.S. provisional application serial No. 60/441,004 filed Jan. 17, 2003, both of which are hereby incorporated by reference in their entirety.

### FIELD OF THE INVENTION

The present invention relates to ultra white nonwoven composite materials and a process for their manufacture.

### BACKGROUND OF THE INVENTION

For many applications where nonwoven composite materials and similar materials are used, color is an important consideration. For some applications, it is desirable to have a white material. In fact, the whiteness associated with cleanliness and purity is of paramount importance in many instances. For example, the color of the surface materials in products such as baby wipes, mops, diapers, feminine hygiene products, incontinent devices or surgical drapes affects the aesthetic appeal to the consumer, and thus the marketability of the products.

Conventional nonwoven composite materials and other fiber-based web material can exhibit an undesirable off-white color, due to the manufacturing and processing steps involved in preparing natural fibers such as cellulose-based fibers for use in web-based materials. Additives such as binders and bicomponent fibers can contribute to the off-white color.

An improvement in the optical aesthetics and opacity of the materials, as well as in the fiber used to make the materials, can be achieved by the addition of additives such as delustrants or optical brighteners. These additives can be tailored to meet the end use requirements such as, for example a pre-moistened baby wipe. Additional additives, such as a blue toner, can be used to mask unwanted colors.

However, while the delustrant provides some optical opacity, it still lacks a whitened visual effect that consumers associate with improved hygenics.

Therefore, there is an existing and continual need to improve the collective whiteness, brightness and opacity of nonwoven materials.

### SUMMARY OF THE INVENTION

The present invention provides for an ultra white nonwoven wipe material with superior whiteness, brightness and opacity.

In one embodiment, the invention is an ultra white nonwoven material having a basis weight from about 25 gsm (grams per square meter) to about 250 gsm and a density from about 0.03 to about 0.15 g/cc including:

(A)from about 57 to about 90 weight percent of a bulk fiber,

(B)optionally, from about 1 to about 8 weight percent of an emulsion polymer binder, and

(C)from about 5 to about 35 weight percent bicomponent fiber

where the material has an aesthetic optical value (AOV) of 75 or greater.

In another embodiment, the invention provides for an ultra white nonwoven material having a basis weight from about 40 gsm to about 100 gsm and a density from about 0.03 to about 0.15 g/cc including:

(A)from about 57 to about 90 weight percent of a bulk fiber,

(B)optionally, from about 1 to about 8 weight percent of an emulsion polymer binder, and

(C)from about 5 to about 35 weight percent bicomponent fiber, and

where the material has an AOV of 75 or greater.

In one embodiment of the invention, the nonwoven material has a brightness of about 80 or greater, more preferably about 85 or greater.

In another embodiment, the nonwoven material has an opacity of about 55 percent or greater.

The bulk fibers of the present invention may be natural, synthetic, or a mixture thereof. In one embodiment, the fibers may be cellulose-based pulp fibers, one or more synthetic fibers, or a mixture thereof. Any cellulose fibers known in the art, including cellulose fibers of any natural origin, such as those derived from wood pulp, may be used in a cellulosic layer. Preferred cellulose fibers include, but are not limited to, digested fibers, such as kraft, prehydrolyzed kraft, soda, sulfite, chemi-thermal mechanical, and thermo-mechanical treated fibers, derived from softwood, hardwood or cotton linters. More preferred cellulose fibers include, but are not limited to, kraft digested fibers, including prehydrolyzed kraft digested fibers. Suitable for use in this invention are the cellulose fibers derived from softwoods, such as pines, firs, and spruces. Other suitable cellulose fibers include those derived from Esparto grass, bagasse, kemp, flax and other lignaceous and cellulosic fiber sources. Suitable cellulose fibers include, but are not limited to, bleached Kraft southern pine fibers sold under the trademark FOLEY FLUFFS® (Buckeye Technologies Inc., Memphis, Tenn.)N.

In one embodiment of this invention, bulk fibers suitable for use in the structures of the invention may include cellulosic or synthetic fibers or blends thereof. Most preferred is wood cellulose. Also preferred is cotton linter pulp, chemically modified cellulose such as crosslinked cellulose fibers and highly purified cellulose fibers, such as Buckeye HPF (each available from Buckeye Technologies Inc., Memphis, Tenn.). The fluff fibers may be blended with synthetic fibers, for example polyester such as PET, nylon, polyethylene or polypropylene.

In certain embodiments of the invention, the bicomponent fibers contain a delustrant. Preferably, the delustrant is titanium dioxide. In one embodiment, the delustrant is present in the sheath of the bicomponent fibers. In another embodiment, the delustrant is present in the core of the bicomponent fibers.

In certain embodiments, the bicomponent fibers also contain an optical brightener. Preferably, the optical brightener is bis(benzoxazolyl) stilbene. In one embodiment, the optical brightener is present in the sheath of the bicomponent fibers. In another embodiment, the optical brightener is present in the core of the bicomponent fibers.

The materials of the present invention may also have two or more distinct strata where the composition of any one stratum is different from at least one adjacent stratum. Preferably, the material has two outer strata and one or more inner strata, and the bulk fiber of the outer strata have a brightness of 85 or greater. In another embodiment, the material has two outer strata and one or more inner strata and the weight percent bicomponent fiber of the inner stratum is greater than the weight percent bicomponent fiber in the outer strata.

In the invention, the material can be produced by airlaid processes.

Within the scope of the invention is a process for the production of a material as described above comprising airlaying from about 57 to about 90 weight percent of a bulk fiber, and from about 5 to about 35 weight percent bicomponent fiber to form material with one or more strata and where the material has a whiteness L of about 90 or greater.

Preferred materials have an Aesthetic Optical Value (as defined below) of about 75 or greater.

Preferably, the ultra white nonwoven material of the invention may be used as a component of a wide variety of absorbent structures, including but not limited to diapers, feminine hygiene materials, incontinent devices, surgical drapes and associated materials, as well as wipes and mops.

Also within the scope of the invention is the bicomponent fiber comprising a core made of polyester, a sheath made of polyethylene comprising an optical brightener in an amount of from about 100 to about 400 ppm by weight of the sheath component and a delustrant in an amount of from about 0.2 percent by weight to about 0.4 percent by weight of the sheath component. Preferably, the optical brightener is a bis(benzoazolyl) stilbene and the delustrant is titanium dioxide. The fibers preferably have a brightness of about 98 or greater. In other embodiments, the fibers have a whiteness (L*) value of about 90 or greater, a redness/greenness (a*) value of about 3.2 or greater, and a blueness/yellowness (b*) value of about −10 or less.

These and other aspects of the invention are discussed more in the detailed description and examples.

### DETAILED DESCRIPTION OF THE INVENTION

Optical Aesthetics

As used herein, “optical aesthetics” for the fibers, particularly the bicomponent fibers, or the article in which it is incorporated, can be measured in terms of the enhanced brightness, enhanced whiteness (L*) and reduced yellowing (b*) as well as its opacity.

Aesthetic Optical Value (AOV) uses visual and physical properties of the wipe to give an overall score. The higher the numerical score, the more desirable the optical aesthetics for the web material. The AOV is defined as:

AOV=[(Opacity)+Brightness+L*−b*)×Caliper/basis weight]×20,

where the caliper is in mm and the basis weight is in g/m². Preferably, the nonwoven materials of the present invention have an aesthetic optical value of about 75 or greater, more preferably of about 80 or greater, more preferably of about 85 or greater, more preferably of about 90 or greater, and even more preferably of about 95 or greater.

As used herein, “L*” is a parameter that is related to whiteness on a grayscale with positive values representing relative whiteness and negative values representing more blackness. As used herein, “a*” is a parameter that is related to relative redness versus greenness, with positive values representing more redness and negative values representing more greenness. As used herein, “b*” is a parameter that is related to relative blueness versus yellowness, with positive values representing more yellowness and negative values representing more blueness.

“Opacity” is defined as the ratio of the apparent reflectance of one sheet of a web with a black backing to the apparent reflectance of the sheet with a white backing. Opacity, Y, measurements determine opacity in reflectance mode by a contrast ratio measurement. Therefore, a sample whose apparent reflectance is not changed by changing its backing from white to black will have an opacity of 100, whereas, a sample whose apparent reflectance changes from a high value to zero by changing the backing from white to black will have an opacity of zero. The Y value of the specimen backed by a black glass or light trap is divided by the Y value of the specimen backed by a white tile. The resulting fraction is Y%, or opacity, which is calculated as follows:

Y_{black backing}

Opacity (Y)=______×100

Y_{white backing}

The L* and b* values, as measured by the ColorQuest XE Spectrophotometer (Technidyne Technibrite Micro ™TB-1C, New Albany, Ind.) for example, are related to particular color scales. For example, the Hunter Scale refers to a testing scale that is used for color measurements, where CIE has a slightly different mathematical models for determining the color of a material. Hunter L and b values are as follows:

| | | |
|---|---|---|
| L = 100 | Ka (X/Xo − Y/Yo)a = | Kb (Y/Yo − Z/Zo)b = |
| (Y/Yo)^{1/2} | (Y/Yo)^{1/2} | (Y/Yo)^{1/2} |

The CIE scale is computed as follows:

| | |
|---|---|
| L* = 116(Y/Yo)^{1/3} − 16 | a* = 500 [(X/Xo)^{1/3} − (Y/Yo)^{1/3}] |
| b* = 500 [(Y/Yo)^{1/3} − (Z/Zo)^{1/3}] | |

where,

X/Xo, Y/Yo and Z/Zo>0.01

X, Y, Z are tristimulus values

Xo, Yo, Zo are tristimulus values for perfect diffuser for illuminant used

Ka, Kb are chromaticity coefficients for illuminants used

For D₆₅ illuminant and 2° observer setting used,

Xo=95.047, Yo=100.000, Zo=108.883, Ka=172.3 and Kb=67.2

The opacity, brightness and whiteness, L*, are consumer preferred values while the yellowness, b*, is not a consumer preferred value. The color values are all additive and given equal weight. The basis weight is correlated to cost and not consumer preferred, and is divided against the visual values. This prevents an ultra heavy product, such as, for example, a 300 gsm wipe, from being a preferred product as its basis weight would have too much of an influence. Multiplication at the end by 20 is to bring the numbers near a “100” that would be recognized as an outstanding product.

As used herein, the term “ultra white” refers to nonwoven material having a whiteness “L” of 90 or greater, and/or having an AOV of about 75 or greater. The ultra white wipe material and the ultra white nonwoven material of this invention have an AOV of about 75 or greater. More desirably, the AOV is about 80 or greater. Still more desirably, the AOV is about 85 or greater. Preferably, the AOV is about 90 or greater. More preferably, the AOV is about 95 or greater.

Nonwoven Materials

The present invention provides for an ultra white nonwoven wipe material which includes bicomponent fibers, a binder, and commercially available bright fluff pulp.

As used herein, “nonwovens” refer to a class of material, including but not limited to textiles or plastics. “Wipes” are therefore a sub-class of the nonwovens.

Bicomponent fibers having a core and sheath are known in the art. Many varieties are used in the manufacture of nonwoven materials, particularly those produced by airlaid techniques. Various bicomponent fibers suitable for use in the present invention are disclosed in U.S. Pat. Nos. 5,372,885 and 5,456,982, both of which are hereby incorporated by reference in their entirety. Examples of bicomponent fiber manufacturers include KoSa (Salisbury, N.C.), Trevira (Bobingen, Germany) and ES Fiber Visions (Athens, Ga.).

Bicomponent fibers may incorporate a variety of polymers as their core and sheath components. Bicomponent fibers that have a PE (polyethylene) or modified PE sheath typically have a PET (polyethyleneterephthalate) or PP (polypropylene) core. In one embodiment, the bicomponent fiber has a core made of polyester and sheath made of polyethylene. The denier of the fiber preferably ranges from about 1.0 dpf to about 4.0 dpf, and more preferably from about 1.5 dpf to about 2.5 dpf. The length of the fiber is preferably from about 3 mm to about 12 mm, more preferably from about 4.5 mm to about 7.5 mm.

Various geometries can be used for the bicomponent fiber of this invention, including concentric, eccentric, islands-in-the-sea, and side-by-side. The relative weight percentages of the core and sheath components of the total fiber may be varied.

The present invention also includes a binder. Preferred binders include but are not limited to ethyl vinyl acetate copolymer such as AirFlex 124 (Air Products, Allentown, Pa.) with 10% solids and 0.75% by weight Aerosol OT (Cytec Industries, West Paterson, N.J.), which is an anionic surfactant. Other classes of emulsion polymer binders such as styrene-butadiene and acrylic binders may also be used. Binders AirFlex 124 and 192 (Air Products, Allentown, Pa.) having an opacifier and whitener, such as, for example, titanium dioxide, dispersed in the emulsion may also be used.

The nonwoven materials of the invention also include a commercially available bright fluff pulp including, but not limited to, southern softwood fluff pulp (such as Treated FOLEY FLUFFS ® or HiBrite ™ Treated FOLEY FLUFFS ®), northern softwood sulfite pulp (such as T 730 from Weyerheuser, or hardwood pulp (such as eucalyptus). The preferred pulp is HiBrite ™ Treated FOLEY FLUFFS ® from Buckeye Technologies Inc. (Memphis, Tenn.), however any absorbent fluff pulp with brightness of 85 or greater, as measured using a Technidyne Technibrite TB-1C Brightness & Color Meter (New Albany, Ind.), may be used. Mixtures of various bright pulps may also be used, and mixtures including lesser bright pulps may be used so long as the brightness of the mixture is 85 or greater.

Delustrants and Optical Brighteners

In a preferred embodiment of the present invention, the bicomponent fiber contains a delustrant. In the present invention, there are a significant number of potential delustrants that are suitable for use in the bicomponent fibers of the invention. For example, the delustrants include, but are not limited to titanium dioxide, zinc oxide, silicon dioxide, and aluminum silicates. Titanium dioxide is the preferred delustrant. The use of titanium dioxide in the core of the fiber yields a small improvement in the opacity of the fiber. However, incorporation of titanium dioxide into the sheath of the fiber gives a significant improvement in the opacity. A certain amount of titanium dioxide in the sheath is required to give visually enhanced opacity to the fiber and the article in which the fiber is used, preferably from about 0.2 percent by weight to about 0.4 percent by weight of the sheath component. Adding additional titanium dioxide beyond this level has little aesthetic impact. Too high a level of titanium dioxide should be avoided as it gives rise to processing problems during the production of the bicomponent fiber.

Preferably, the bicomponent fiber contains from about 0.01 to about 5 percent by weight of a delustrant, more preferably from about 0.2 to about 0.4 percent by weight of a delustrant. These ranges refer not only to the sheath, but also to the overall bicomponent fiber. This is due to the fact that the core of the bicomponent fiber is made, for example, of polyethylene terephthalate (PET) that also has titanium dioxide at about the same level. The core and sheath constitute about 50% of the overall fiber composition (by weight) and thus, the levels of the core and sheath, as well as the overall bicomponent fiber, are within these ranges.

In the preferred embodiment, the bicomponent fiber may also contain an optical brightener. The use of optical brighteners in the core of the bicomponent fiber provides little if any improvement in the optical aesthetics. However, the use of optical brighteners in the sheath of the bicomponent fiber gives a significant improvement in optical aesthetics. There are a number of commercially available optical brighteners that can be used to enhance the optical aesthetics. Examples of optical brighteners which may be used in the present invention are disclosed in U.S. Pat. Nos. 5,985,389; 4,794,071; 3,260,715; and 3,322,680, all of which are hereby incorporated by reference in their entirety. For example, the optical brighteners include, but are not limited to bis(benzoxazolyl) stilbenes, coumarin derivatives, 1,3-diphenyl-2-pyrazolines, the naphtalimides, and the benzoxazole substitutes. Bis(benzoxazolyl) stilbenes are the preferred brightener.

To visually enhance the whiteness and brightness while reducing the yellowing of the fiber, and the article in which it is incorporated, the amount of optical brightener in the sheath preferably is from about 20 ppm to about 1 percent by weight, and more preferably from about 100 to about 400 ppm by weight of the sheath component. Optical brightener added above this level has little additional visual impact and can start to negatively impact the optical aesthetics as well as significantly increase the cost of the fiber and article.

Preferred bicomponent fibers may contain a delustrant in the core, the sheath, or both the core and the sheath, and may also contain an optical brightener in the core, the sheath, or both the core and the sheath. A highly preferred material is a bicomponent fiber with a polyethylene sheath containing from about 0.2 to about 0.4 percent by weight of titanium dioxide in the entire fiber and from about 100 to about 400 ppm of bis(benzoxazolyl) stilbene in the sheath.

Methods of Producing Ultra White Material

Various materials, structures and manufacturing processes useful in the practice of this invention are disclosed in U.S. Pat. Nos. 6,241,713; 6,353,148; 6,353,148; 6,171,441; 6,159,335; 5,695,486; 6,344,109; 5,068,079; 5,269,049; 5,693,162; 5,922,163; 6,007,653; 6,420,626,. 6,355,079, 6,403,857, 6,479,415, and 6,495,734; and in U.S. patent applications with serial numbers and filing dates, Ser. No. 09/719,338 filed Jan. 17, 2001; Ser. No. 09/475,850 filed Dec. 30, 1999; Ser. No. 09/469,930 filed Dec. 21, 1999; Ser. No. 09/578,603 filed May 25, 2000; Ser. No. 09/774,248 filed Jan. 30, 2001; and Ser. No. 09/854,179 filed May 11, 2001 all of which are hereby incorporated by reference in their entirety.

A variety of processes can be used to assemble the materials used in the practice of this invention to produce the ultra white materials of this invention, including but not limited to, traditional wet laying process and dry forming processes such as airlaying.

Preferably, the ultra white materials can be prepared by airlaid processes. Airlaid processes include the use of multiple forming heads to deposit raw materials of differing compositions in selected order in the manufacturing process to produce a product with distinct strata. This allows great versatility in the variety of products which can be produced. In one embodiment of this invention, a structure is formed with three forming heads to produce material with three strata, where an inner stratum is surrounded by two outer strata. In another embodiment of the application, the more costly ultra white materials are used in the outer strata, while the central core stratum contains less costly materials.

Various manufacturing processes of bicomponent fibers, and treatment of such fibers with additives, useful in the practice of this invention are disclosed in U.S. Pat. Nos. 4,394,485, 4,684,576, 4,950,541, 5,045,401, 5,082,899, 5,126,199, 5,185,199, and 5,705,565, all of which are hereby incorporated by reference in their entirety. In the present invention, however, the additives applied to the fibers are specific to delustrants and brighteners. For example, in one embodiment, a bicomponent is formed by adding a dry powder of additive(s) to, for example, polyethylene. The ingredients are mixed, melted, cooled, and rechipped. The final chips are then incorporated into a fiber spinning process to make the desired bicomponent fiber. The rate of forming or temperatures used in the process are similar to those known in the art, for example similar to U.S. Pat. No. 4,950,541, where maleic acid or maleic compounds are integrated into bicomponent fibers, and which is incorporated herein by reference.

In one aspect of the invention, the ultra white nonwoven material may be used as component of a wide variety of absorbent structures, including but not limited to diapers, feminine hygiene materials, incontinent devices, surgical drapes and associated materials, as well as wipes and mops.

### EXAMPLES

The present invention will be better understood by reference to the following Examples, which are provided as exemplary of the invention, and not by way of limitation.

### Example 1

In the present example, raw materials of bicomponent fibers, a binder and a commercially available bright fluff pulp were combined to prepare padformed samples, and to compare the resultant samples of various pulps.

The bicomponent fibers used were KoSa T 255 (Salisbury, N.C.), having a denier of 2.0 dpf and a length of 6.0 mm, and KoSa IJP 314 (Salisbury, N.C.), having a denier of 2.0 dpf and a length of 6.0 mm. Both of these bicomponent fibers have a core made of polyester and a sheath made of polyethylene. The IJP 314 bicomponent fibers also contained titanium dioxide, TiO₂, in the sheath. Additionally, KoSa IJP 325, and KoSa T255 lots 35163A and 35167A (Salisbury, N.C.) were tested. W55 is a bicomponent fiber of the invention containing TiO₂ and optical brightener.

Cellulose tissue, having a basis weight of 18 gsm, was used as the carrier and topsheet to facilitate pad formation. Other cellulose or synthetic fiber tissues may also be used.

The brightness and L whiteness were measured using a commercial Brightness/Color Measuring System, namely Technidyne Technibrite Micro™ TB-1C (New Albany, Ind.).

The brightness method follows the ISO standard 2469 and TAPPI T-525 method. This method is based on determining the amount of diffuse reflected light at a wavelength of 457 nanometers. A stack of 16 layers of approximately 5 cm by 5 cm (2 inches by 2 inches) test substrates is placed below the light source. The “SCAN” button is pressed. Then the “PRINT” button is pressed. The brightness and “L”, “a” and “b” values are printed. The brightness value obtained is also called ISO brightness.

For measuring the brightness and color properties of the bicomponent fibers, 3 grams of bulk fibers were placed in a glass-faced, stainless steel cylindrical cup (2″ diameter and 2″ height), provided by Technidyne (New Albany, Ind.). The base of the cup has a spring-loaded piston which pushes up against the material, compressing it against the glass surface.

Table 1 shows the brightness and color properties of various bicomponent fibers as measured by the aforementioned system.

TABLE 1
Brightness and Color Properties of Bicomponent Fibers

| Sample | Brightness | L | a | B |
|---|---|---|---|---|
| IJP 314 | 74.5 | 86.6 | −0.24 | 0.48 |
| IJP 325 | 86.4 | 89.5 | 1.96 | −4.14 |
| 35163A | 76.1 | 88.2 | −0.30 | 1.54 |
| 35167A | 86.6 | 89.4 | 2.11 | −4.45 |
| W55 | 86.4 | 89.5 | 1.31 | −3.93 |

Opacity

The opacity was measured using a commercial Opacity Measuring system, Technidyne BNL-2 Opacimeter (New Albany, Ind.). The measurement of opacity conforms to TAPPI T-425 method. Only one sheet about 15 cm by 15 cm (6 inches by 6 inches) is used for measurement per sample. Extreme care is taken to ensure that the sheet is clean prior to measurement. Three opacity determinations, one at the center and two at the opposite corners, are made on a sheet and the average is reported.

Table 2 shows the results of brightness testing on various pulps used to produce the wipe material of this invention.

TABLE 2
Brightness of Pulps Used

| Pulp Type | Brightness(pulp sheet) |
|---|---|
| Treated FOLEY FLUFFS ® | 88.0 |
| (TFF) | |
| (Buckeye Technologies Inc., Perry, FL) | |
| HiBrite ™ | 89.5 |
| Treated FOLEY FLUFFS ® | |
| (HBTFF) | |
| (Buckeye Technologies Inc., Perry, FL) | |
| Rauma | 85.5 |
| (UPM-Kymmene, Rauma, Finland) | |
| Eucalyptus | 90.1 |
| (Aracruz, Espirito Santo, Brazil) | |
| WeyerheuserT 730 | 93.5 |
| (Federal Way, WA) | |

Ten variations of webs or wipe material 62-1 through 62-10 were made in the laboratory padformer. All the webs were formed in three layers: top, middle and bottom and were multibonded airlaid (MBAL).

A 35.6 cm by 35.6 cm (14 inches by 14 inches) piece of tissue was placed on the formation screen of the laboratory padformer. Table 3 shows the amount of pulp and bicomponent fibers used for each layer of the pad as well as the amount of binder sprayed on each side of the pad. Table 3 also shows the type of pulp and bicomponent fiber used for each layer of the pad. First, the bottom layer is formed on the tissue. For the bottom layer, the required amounts of fluff, corresponding to 17.55 gsm, and bicomponent fibers, corresponding to 3.90 gsm, were weighed and mixed. The mixture was divided into eight equal portions. The first portion was formed and the formation screen and pad were turned one quarter of a turn. Then the second formation was formed and the formation screen and pad were rotated one quarter of a turn. Thus, by the time the full amount for the bottom layer was placed, the pad had made two full turns. This ensured the uniformity of the deposited layer. Similarly, the mixture for the middle layer was divided into eight portions and each part was formed, followed by one quarter of a turn. Finally, the top layer was placed. The pad was then covered with another layer of tissue and consolidated under 0.1 psi pressure. After consolidation, the pad was trimmed to 30.5 cm by 30.5 cm (12 inches by 12 inches). After that, tissue was removed from one side of the pad. That side was sprayed with the required amount, corresponding to 1.30 gsm of 10% by weight AirFlex 124 (Air Products, Allentown, Pa.)containing Aerosol OT (Cytec Ind., West Paterson, N.J.) 0.75% by weight using a Preval sprayer (Haubold Technik, Germany). Aerosol OT (Cytec Industries, West Paterson, N.J.) was added to the binder to enhance the hydrophilicity of the web. The pad was then dried at 106° C. for 3 minutes. The pad was then turned over and the same procedure was used to coat the second side with AirFlex 124 (Air Products, Allentown, Pa.). The pad was placed in the oven at 163° C. for 1 minute for curing. Finally, the pad was pressed to a density of 0.06 g/cc using a heated platen Carver press (Wabash, Ind.) at 135° C. for 3 minutes under 69.4 psi (where psi equals pounds per square inch). Metal shims were inserted between the platens at the four corners to ensure nominal target caliper and density.

TABLE 3
Composition of Padformed Sample 62-1

| | | Bico (T 255) | Binder (AF | Total BW | Density |
|---|---|---|---|---|---|
| | Pulp (gsm) | (gsm) | 124) (gsm) | (gsm) | (g/cc) |
| Top | 17.55 (TFF) | 3.90 | 1.30 | 22.75 | |
| Middle | 13.65 (TFF) | 5.85 | | 19.50 | |
| Bottom | 17.55 (TFF) | 3.90 | 1.30 | 22.75 | |
| | | | | 65.0 | 0.06 |

Samples 62-2 through 62-10 were prepared similarly to Sample 62-1, but with the compositions and pulp and bicomponent fiber types given in Tables 4 through 14.

TABLE 4
Composition of Padformed Sample 62-2

| | | Bico | | | |
|---|---|---|---|---|---|
| | | (T 255) | Binder (AF | Total BW | Density |
| | Pulp (gsm) | (gsm) | 124) (gsm) | (gsm) | (g/cc) |
| Top | 17.55 (Rauma) | 3.90 | 1.30 | 22.75 | |
| Middle | 13.65 (Rauma) | 5.85 | | 19.50 | |
| Bottom | 17.55 (Rauma) | 3.90 | 1.30 | 22.75 | |
| | | | | 65.0 | 0.06 |

TABLE 5
Composition of Padformed Sample 62-3

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 17.55 (TFF) | 3.90 | 1.30 | 22.75 | |
| Middle | 13.65 (TFF) | 5.85 | | 19.50 | |
| Bottom | 17.55 (TFF) | 3.90 | 1.30 | 22.75 | |
| | | | | 65.0 | 0.06 |

TABLE 6
Composition of Padformed Sample 62-4

| | Pulp | Bico (IJP | Binder (AF | Total BW | Density |
|---|---|---|---|---|---|
| | (gsm) | 314) (gsm) | 124) (gsm) | (gsm) | (g/cc) |
| Top | 17.55 (TFF) | 3.90 | 1.30 | 22.75 | |
| Middle | 6.83 (TFF) | 5.85 | | 19.50 | |
| | 6.83 | | | | |
| | (Eucalyptus) | | | | |
| Bottom | 17.55 (TFF) | 3.90 | 1.30 | 22.75 | |
| | | | | 65.0 | 0.06 |

TABLE 7
Composition of Padformed Sample 62-5

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 17.55 (HBTFF) | 3.90 | 1.30 | 22.75 | |
| Middle | 13.65 (HBTFF) | 5.85 | | 19.50 | |
| Bottom | 17.55 (HBTFF) | 3.90 | 1.30 | 22.75 | |
| | | | | 65.0 | 0.06 |

TABLE 8
Composition of Padformed Sample 62-5 HD

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 17.55 (HBTFF) | 3.90 | 1.30 | 22.75 | |
| Middle | 13.65 (HBTFF) | 5.85 | | 19.50 | |
| Bottom | 17.55 (HBTFF) | 3.90 | 1.30 | 22.75 | |
| | | | | 65.0 | 0.13 |

TABLE 9
Composition of Padformed Sample 62-6

| | | Bico | Binder (AF | Total | |
|---|---|---|---|---|---|
| | Pulp | (IJP 314) | 124) | BW | Density |
| | (gsm) | (gsm) | (gsm) | (gsm) | (g/cc) |
| Top | 17.55 (HBTFF) | 3.90 | 1.30 | 22.75 | |
| Middle | 6.83 (HBTFF) | 5.85 | | 19.50 | |
| | 6.83 (Eucalyptus) | | | | |
| Bottom | 17.55 (HBTFF) | 3.90 | 1.30 | 22.75 | |
| | | | | 65.0 | 0.06 |

TABLE 10
Composition of Padformed Sample 62-6 HD

| | | Bico | Binder (AF | Total | |
|---|---|---|---|---|---|
| | Pulp | (IJP 314) | 124) | BW | Density |
| | (gsm) | (gsm) | (gsm) | (gsm) | (g/cc) |
| Top | 17.55 (HBTFF) | 3.90 | 1.30 | 22.75 | |
| Middle | 6.83 (HBTFF) | 5.85 | | 19.50 | |
| | 6.83 (Eucalyptus) | | | | |
| Bottom | 17.55 (HBTFF) | 3.90 | 1.30 | 22.75 | |
| | | | | 65.0 | 0.13 |

TABLE 11
Composition of Padformed Sample 62-7

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 17.55 (T 730) | 3.90 | 1.30 | 22.75 | |
| Middle | 13.65 (T 730) | 5.85 | | 19.50 | |
| Bottom | 17.55 (T 730) | 3.90 | 1.30 | 22.75 | |
| | | | | 65.0 | 0.06 |

TABLE 12
Composition of Padformed Sample 62-8

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 11.05 (HBTFF) | 3.90 | 1.30 | 16.25 | |
| Middle | 26.65 (T 730) | 5.85 | | 32.50 | |
| Bottom | 11.05 (HBTFF) | 3.90 | 1.30 | 16.25 | |
| | | | | 65.0 | 0.06 |

TABLE 13
Composition of Padformed Sample 62-9

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 16.58 (HBTFF) | 3.90 | 1.30 | 21.78 | |
| Middle | 15.60 (T 730) | 5.85 | | 21.45 | |
| Bottom | 16.58 (HBTFF) | 3.90 | 1.30 | 21.78 | |
| | | | | 65.0 | 0.06 |

TABLE 14
Composition of Padformed Sample 62-10

| | | | Binder (AF | Total | |
|---|---|---|---|---|---|
| | Pulp | Bico (IJP 314) | 124) | BW | Density |
| | (gsm) | (gsm) | (gsm) | (gsm) | (g/cc) |
| Top | 16.58 (HBTFF) | 3.90 | 1.30 | 21.78 | |
| Middle | 7.80 (HBTFF) | 5.85 | | 21.45 | |
| | 7.80 (T 730) | | | | |
| Bottom | 16.58 (HBTFF) | 3.90 | 1.30 | 21.78 | |
| | | | | 65.0 | 0.06 |

### RESULTS

Table 15 lists the summary of the performance results of all the padformed samples.

TABLE 15
Summary of Results of the Performance of
the Padformed Samples

| | | Dry | Dry | | | | | | |
|---|---|---|---|---|---|---|---|---|---|
| | BW | Caliper | Density | Opacity | | | | | |
| Sample # | (gsm) | (mm) | (g/cc) | (%) | Bright-ness | Whiteness L | a | b | AOV |
| 62-1 | 67.2 | 1.24 | 0.054 | 58.1 | 84.8 | 94.4 | −.98 | 3.93 | 87 |
| 62-2 | 68.0 | 1.28 | 0.053 | 55.7 | 82.4 | 95.1 | −1.16 | 5.06 | 86 |
| 62-3 | 65.7 | 1.27 | 0.052 | 58.5 | 86.3 | 95.3 | −.77 | 3.58 | 92 |
| 62-4 | 66.7 | 1.26 | 0.053 | 58.7 | 86.2 | 95.3 | −.83 | 3.69 | 90 |
| 62-5 | 66.5 | 1.24 | 0.054 | 60.7 | 85.8 | 94.9 | −.59 | 3.25 | 89 |
| 62-5HD | 66.4 | 0.53 | 0.126 | 64.7 | 85.4 | 95.0 | −.60 | 5.71 | 38 |
| 62-6 | 66.4 | 1.05 | 0.063 | 63.3 | 86.1 | 95.1 | −.62 | 3.22 | 77 |
| 62-6HD | 66.5 | 0.51 | 0.131 | 66.1 | 85.6 | 95.1 | −.62 | 3.75 | 37 |
| 62-7 | 65.9 | 1.18 | 0.056 | 66.6 | 88.4 | 95.5 | −.49 | 2.02 | 89 |
| 62-8 | 69.2 | 1.06 | 0.065 | 62.5 | 85.3 | 94.8 | −.63 | 5.15 | 73 |
| 62-9 | 67.5 | 1.08 | 0.063 | 60.6 | 85.3 | 94.6 | −.67 | 3.94 | 76 |
| 62-10 | 68.3 | 1.05 | 0.065 | 61.8 | 84.8 | 93.9 | −.72 | 4.00 | 73 |

### Example 2

In the present Example, raw materials were combined to form pilot samples.

IJP 325 bicomponent fiber (KoSa, Salisbury, Tex.), having a denier of 2.0 dpf and 6.0 mm fiber length, was used. The bicomponent fibers had a core made of polyester and a sheath made of polyethylene. These fibers contained titanium dioxide, TiO₂, and optical brightener in the sheath. The binder used was an ethyl vinyl acetate copolymer emulsion such as AirFlex 124, (Air Products, Allentown, Pa.), with 10% solids and 0.75% by weight Aerosol OT surfactant (Cytec Industries, West Paterson, N.J.).

The structures shown in Samples 1 through 12A were prepared on a DannWebb pilot scale airlaid manufacturing unit.

Sample 1 was prepared in one pass through the three forming head airlaid pilot line. The first forming head added a mixture of 17 gsm of HiBrite™ treated FOLEY FLUFFS ® pulp (Buckeye Technologies Inc., Memphis, Tenn.) and 4 gsm of IJP 325 bicomponent fibers (KoSa, Salisbury, N.C.). The second forming head added a mixture of 13 gsm of HiBrite ™ treated FOLEY FLUFFS ® pulp (Buckeye Technologies Inc., Memphis, Tenn.) and 6 gsm of IJP 325 bicomponent fibers (KoSa, Salisbury, N.C.). The third forming head added a mixture of 17 gsm of HiBrite ™ treated FOLEY FLUFFS ® pulp (Buckeye Technologies Inc., Memphis, Tenn.) and 4 gsm of IJP 325 bicomponent fibers (KoSa, Salisbury, N.C.). Immediately after this, the web was compacted via the compaction roll. Then, 2 gsm of AirFlex 124 latex emulsion was sprayed onto the top of the web. Then the web was cured in a Moldow Through Air Tunnel Drier (Moldow Systems AS, Vaerloese, Denmark) at a temperature of temperature 145-155° C. After the structure was cured in the oven, 2.0 gsm of AirFlex 124 latex foam was applied to the bottom side. The web was again cured in a Fleissner Through Air Drum Drier (Fleissner GmbH & Co., Egelsbach, Germany) at a temperature of 130-145° C. After this the web was wound and collected. The machine speed was 10-20 meters/minute.

Samples 2 through 12A were prepared similarly to Sample 1, but with the compositions given in Table 16 and 17.

TABLE 16
Composition of the Pilot Samples 1-6

| | | 1 | 2 | 3 | 4 | 5 | 6 |
|---|---|---|---|---|---|---|---|
| | | (gsm) | (gsm) | (gsm) | (gsm) | (gsm) | (gsm) |
| Top | Binder | 2 | 2 | 2 | 2 | 2 | 2 |
| Layer | Spray (top) | | | | | | |
| Pulp - | 17 | 19 | 19 | 21 | 17 | 16 | |
| HBTFF | | | | | | | |
| Bico - | 4 | 4 | 3 | 3 | 4 | 4 | |
| IJP325 | | | | | | | |
| Middle | Pulp - | 13 | 9 | 9 | 10 | 16 | |
| Layer | HBTFF | | | | | | |
| Pulp - T | | | | | | 15 | |
| 730 | | | | | | | |
| Bico - | 6 | 6 | 8 | 6 | 6 | 6 | |
| IJP325 | | | | | | | |
| Bottom | Pulp - | 17 | 19 | 19 | 21 | 17 | 16 |
| Layer | HBTFF | | | | | | |
| Bico - | 4 | 4 | 3 | 3 | 4 | 4 | |
| IJP325 | | | | | | | |
| Binder | 2 | 2 | 2 | 2 | 2 | 2 | |
| Foam | | | | | | | |
| (bottom) | | | | | | | |
| | Total BW | 65 | 65 | 65 | 68 | 68 | 65 |
| | Thickness | 1.12 | 1.12 | 1.12 | 1.12 | 1.12 | 1.12 |
| | (mm) | | | | | | |

| | | 7 | 8 | 9 | 10 | 11 | 12 | 12A |
|---|---|---|---|---|---|---|---|---|
| | | (gsm) | (gsm) | (gsm) | (gsm) | (gsm) | (gsm) | (gsm) |
| Top | Binder | 2 | 2 | 2 | 2 | 2 | 2 | 2 |
| Layer | Spray | | | | | | | |
| | (top) | | | | | | | |
| Pulp - FF | | | | | | | 18 | |
| Pulp - | 14.5 | 18 | 17 | 18 | 17 | 18 | | |
| HBTFF | | | | | | | | |
| Bico - | 3 | 3 | 3 | 3 | 4 | 4 | 4 | |
| IJP325 | | | | | | | | |
| Middle | Pulp - | | | 13 | 13 | 16 | 14 | 14 |
| Layer | HBTFF | | | | | | | |
| Pulp - T | 18 | 11 | | | | | | |
| 730 | | | | | | | | |
| Bico - | 8 | 8 | 8 | 6 | 6 | 6 | 6 | |
| IJP325 | | | | | | | | |
| Bottom | Pulp - FF | | | | | | | 18 |
| Layer | | | | | | | | |
| Pulp - | 14.5 | 18 | 17 | 18 | 17 | 18 | | |
| HBT-FF | | | | | | | | |
| Bico - | 3 | 3 | 3 | 3 | 4 | 4 | 4 | |
| IJP325 | | | | | | | | |
| Binder | 2 | 2 | 2 | 2 | 2 | 2 | 2 | |
| Foam | | | | | | | | |
| (bottom) | | | | | | | | |
| | Total BW | 65 | 65 | 65 | 65 | 68 | 68 | 68 |
| | Thickness | 1.12 | 1.12 | 1.12 | 1.12 | 1.12 | 1.12 | 1.12 |
| | (mm) | | | | | | | |

### RESULTS

Table 18 summarizes the performance results of all the pilot samples.

TABLE 18
Summary of the Results of Pilot Samples 1-12A

| Sam- | | Dry | Dry | | | | |
|---|---|---|---|---|---|---|---|
| ple | BW | Caliper | Density | Opacity | | Whiteness | |
| # | (gsm) | (mm) | (g/cc) | (%) | Brightness | L | AOV |
| 1 | 63.9 | 0.74 | 0.09 | 61.8 | 91.4 | 95.5 | 58 |
| 2 | 65.2 | 0.72 | 0.09 | 62.4 | 91.9 | 95.7 | 55 |
| 3 | 65.7 | 0.82 | 0.08 | 60.8 | 91.7 | 95.6 | 62 |
| 4 | 67.7 | 0.76 | 0.09 | 61.1 | 91.2 | 95.9 | 56 |
| 5 | 68.4 | 0.75 | 0.09 | 63.7 | 92.4 | 95.9 | 55 |
| 6 | 63.9 | 0.77 | 0.08 | 63.6 | 93.1 | 96.2 | 61 |
| 7 | 63.3 | 1.05 | 0.06 | 62.0 | 94.0 | 96.1 | 84 |
| 8 | 61.9 | 1.09 | 0.06 | 60.6 | 93.2 | 96.0 | 88 |
| 9 | 61.5 | 1.05 | 0.06 | 60.1 | 91.6 | 95.8 | 85 |
| 10 | 63.0 | 1.00 | 0.06 | 62.3 | 92.7 | 95.9 | 80 |
| 11 | 68.0 | 1.08 | 0.06 | 64.5 | 93.0 | 96.1 | 81 |
| 12 | 68.4 | 1.10 | 0.06 | 64.6 | 92.3 | 96.0 | 82 |
| 12A | 70.6 | 1.00 | 0.07 | 65.6 | 87.2 | 95.2 | 70 |

The brightness, L whiteness and opacity were measured using the methods described earlier.

### Example 3

The present Example combined the raw materials to form commercial samples.

Commercial bicomponent fibers, from KoSa (T 255, 2.0 dpf, 6 mm, Lot 35163A), and bicomponent fibers containing TiO₂ and optical brightener in the sheath from KoSa (T 255, Lot 35176A, 2.0 dpf and 6.0 mm fiber length) were used. Both bicomponent fibers had a core made of polyester and a sheath made of polyethylene. AirFlex 124 (Air Products) with 5-10% by weight solids and 0.75% by wt. Aerosol OT surfactant was used. The surfactant was added to improve the hydrophilicity of the web.

Sample FX 0179 was prepared in Buckeye Technologies' commercial airlaid line using only three forming heads per the composition given in Table 19. The first forming head added a mixture of 17.55 gsm of Treated FOLEY FLUFFS ® pulp (Buckeye Technologies Inc., Memphis, Tenn.) and 3.9 gsm of T 255, from KoSa, bicomponent fibers (Salisbury, N.C.). The second forming head added a mixture of 13.65 gsm of Treated FOLEY FLUFFS ® pulp (Buckeye Technologies Inc., Memphis, Tenn.)and 5.85 gsm of KoSa T 255 bicomponent fibers (Salisbury, N.C.). The third forming head added a mixture of 17.55 gsm of Treated FOLEY FLUFFS ® pulp (Buckeye Technologies Inc., Memphis, Tenn.) and 3.9 gsm of KoSa T 255 bicomponent fibers (Salisbury, N.C.). Immediately after this, the web was compacted via the compaction roll. Then, 1.3 gsm of AirFlex 124 latex emulsion was sprayed onto the top of the web. Then the web was dried in a Through Air Tunnel Drier )Moldow Systems AS, Vaerloese, Denmark) (temperature 150-190° C). Then 1.3 gsm of AirFlex 124 latex emulsion was sprayed from below onto the bottom of the web. The web was again dried and cured in another Through Air Tunnel Drier (Fleissner GmbH & Co., Egelsbach, Germany) (temperature 150-190° C.). After this, the web was embossed by the finishing calender and cooled with water spray at the cooling wire. Finally the web was wound and collected. The finishing calender also controls the thickness. The machine speed was 200-300 meters per minute corresponding to a throughput of 2.0-3.0 metric tonnes/hour.

TABLE 19
Product Composition of Sample FX 0179

| | Top Layer | Middle Layer | Bottom Layer |
|---|---|---|---|
| Treated FOLEY | 27% | 21% | 27% |
| FLUFFS ® | (17.55 gsm) | (13.65 gsm) | (17.55 gsm) |
| KoSa T 255 Bico | 6% | 9% | 6% |
| Lot 35163A | (3.9 gsm) | (5.85 gsm) | (3.9 gsm) |
| Latex (AF 124, 5% | 2% | 0% | 2% |
| solids) | (1.3 gsm) | (0 gsm) | (1.3 gsm) |

The target basis weight and caliper for FX 0179 were, respectively, 65 gsm and 1.10 mm. Samples FX 0184A & FX 0184B were prepared similarly to Sample FX 0179, but with the compositions given in Table 20 and 21, respectively.

TABLE 20
Product Composition (% Basis Weight) of
Sample FX 0184A

| | Top Layer | Middle Layer | Bottom Layer |
|---|---|---|---|
| HiBrite ™ Treated | 26% | 20% | 26% |
| FOLEY FLUFFS ® | (16.9 gsm) | (13 gm) | (16.9 gsm) |
| T 255 KoSa Bico | 5.5% | 9% | 5.5% |
| Lot 35167A | (3.58 gsm) | (5.85 gsm) | (3.85 gsm) |
| Latex (AF 124, 7% | 2% | 0% | 2% |
| solids) | (1.3 gsm) | (0 gsm) | (1.3 gsm) |

The target basis weight and caliper for FX 0184A were, respectively, 65 gsm and 1.13 mm.

TABLE 21
Product Composition (% Basis Weight) of
Sample FX 0184B

| | Top Layer | Middle Layer | Bottom Layer |
|---|---|---|---|
| HiBrite ™ Treated | 29% | 20% | 29% |
| FOLEY FLUFFS ® | (20.3 gsm) | (14 gsm) | (20.3 gsm) |
| KoSa T 255 Bico | 5% | 8% | 5% |
| Lot 35167A | (3.5 gsm) | (5.6 gsm) | (3.5 gsm) |
| Latex (AF 124, 7% | 2% | 0% | 2% |
| solids) | (1.4 gsm) | (0 gsm) | (1.4 gsm) |

The target basis weight and caliper for FX 0184B were, respectively, 70 gsm and 1.13 mm.

3B02 was produced on the commercial scale airlaid line. The target basis weight and caliper were, respectively, 65 gsm and 1.13 mm. The product was produced using the four forming heads with composition as shown in Table 22 below. W 55 is the experimental bicomponent fiber containing TiO ₂ and optical brightener, but otherwise has the same specifications as T 255, Lot 35167A, which was used to produce samples FX0184 A & B.

TABLE 22
Product Composition (% Basis Weight) of Sample 3B02

| | Layer 1/ | | | |
|---|---|---|---|---|
| | Bottom | Layer 2 | Layer 3 | Layer 4/Top |
| | (FH 1) | (FH 2) | (FH 3) | (FH 4) |
| HiBrite ™ Treated | 39% | 13% | 12% | 8% |
| FOLEY FLUFF ® | (25.3 gsm) | (8.4 gsm) | (7.8 gsm) | (5.2 gsm) |
| W 55 | 10% | 6.5% | 4.5% | 3% |
| experimental fiber | (6.5 gsm) | (4.2 gsm) | (2.9 gsm) | (1.9 gsm) |
| 2.0 dpf/6 mm | | | | |
| Latex (AF 124, 7% | 2% | 0% | 0% | 2% |
| solids | (1.4 gsm) | (0 gsm) | (0 gsm) | (1.4 gsm) |

Table 23 summarizes the performance results of the samples FX 0179, FX 0184A & B, VIZORB ® 3B02. Table 23 also lists the properties of commercial baby wipe Huggies Natural for comparison.

TABLE 23
Summary of Results of Commercial Samples: FX 0179,
FX 0184 A&B, 3B02

| | | | | | Huggies |
|---|---|---|---|---|---|
| | FX | FX | FX | VIZORB ® | Natural |
| | 0179 | 0184A | 0184B | 3B02 | Baby Wipe |
| Basis Weight | 66 | 62 | 71 | 62.8 | 73 |
| (gsm) | | | | | |
| Dry Caliper | 1.09 | 1.18 | 1.16 | 1.02 | 1.0 |
| (mm) | | | | | |
| Opacity (%) | 56.7 | 62.8 | 68.6 | 63.0 | 75.1 |
| L (whiteness) | 94.4 | 96.3 | 96.4 | 96.5 | 96.9 |
| A | −0.73 | −.87 | −.50 | 0.67 | — |
| B | 3.91 | 2.18 | 1.66 | 0.74 | — |
| Brightness | 84.2 | 92.2 | 92.1 | 92.5 | 89.2 |

### Example 4

As shown in Table 24 below, various nonwoven samples and nonwoven wipe materials and substrates produced with different manufacturing technologies were evaluated for the Aesthetic Optical Value (AOV) and compared to the ultra white wipe. These measurements were done using the ColorQuest XE Spectrophotometer, manufactured by HunterLab (Reston, Va.).

The instrument uses a xenon pulse lamp with d/8° spherical geometry, which conforms to ASTM, ISO, CIE, DIN and JIS standards for reflection measurements. The reflectance measurements are taken at wavelengths of 400 to 700 nanometers. D₆₅ illuminant and 2° observer setting were used for all the measurements. The unit has a UV Control option, which permits accurate measurement of fluorescent and optically brightened samples. The unit uses true double-beam optics that monitor light reflected from the sphere and spectrally compensates for any variation. The Specular excluded port was used for all the measurements. The instrument is interfaced with a PC and all the measurements were taken using the software installed on the PC.

The brightness measurement follows the TAPPI T-452 and ISO 2470 method, as indicated above. This method is based on determining the amount of diffuse light reflected at a wavelength of 457 nanometers. For measurement of color, including L*, a* and b*, and brightness, a stack of 8 layers of 5 cm by 5 cm (2 inches by 2 inches) test substrates was placed in the sample portal. For the measurement of opacity, one sheet, 10 cm by 10 cm (4 inches by 4 inches) is placed in the sample portal.

TABLE 24
Aesthetic Optical Value (AOV)

| | | | | | | | | |
|---|---|---|---|---|---|---|---|---|
| Carded | 100% | 23 | 0.251 | 94.2 | 0.70 | 27.9 | 85.0 | 45 |
| Thermal | PET | | | | | | | |
| Bonded | | | | | | | | |
| Carded | 100% | 18 | 0.275 | 93.8 | 0.79 | 27.6 | 83.7 | 62 |
| Thermal | PET | | | | | | | |
| Bonded | | | | | | | | |
| Spunbond | 100% PP | 24 | 0.268 | 93.4 | 1.20 | 30.3 | 82.5 | 46 |
| Spunbond | 100% PP | 15 | 0.173 | 93.3 | 1.42 | 27.8 | 82.0 | 47 |
| Spunbond | 100% PP | 10 | 0.112 | 93.4 | 1.16 | 17.5 | 82.5 | 43 |
| SMS | 100% PP | 17 | 0.172 | 93.0 | 2.29 | 34.6 | 80.1 | 42 |
| SMMS | 100% PP | 15 | 0.192 | 93.7 | 1.14 | 33.5 | 83.1 | 54 |
| Carded - | 50% PET | 50.8 | 0.4 | 95.4 | 5.87 | 65.5 | 81.0 | 37 |
| Hydroentange | 50% Rayon | | | | | | | |
| Carded - | 50% PET | 47.9 | 0.48 | 94.8 | 5.75 | 63.0 | 79.8 | 46 |
| Hydroentange | 50% Rayon | | | | | | | |
| Carded | 50% PET | 56.83 | 0.307 | 95.4 | 3.46 | 60.8 | 84.1 | 26 |
| | 50% Rayon | | | | | | | |
| Carded - | 50% PET | 89.1 | 0.944 | 96.2 | 1.78 | 76.3 | 88.3 | 55 |
| Pointbond | 50% Rayon | | | | | | | |
| Spunlace | 50% PET | 52.4 | 0.442 | 95.1 | 5.21 | 71.2 | 81.3 | 41 |
| | 50% Pulp | | | | | | | |
| Airlaid - | 25% PET | 61 | 0.49 | 95.5 | 5.48 | 70.1 | 81.6 | 39 |
| Hydroentange | 70% pulp | | | | | | | |
| | 5% Binder | | | | | | | |
| Needlepunched | 100% PET | 78.8 | 0.902 | 93.2 | 2.77 | 52.7 | 80.5 | 51 |
| Needlepunched | 100% PET | 185 | 1.76 | 94.0 | −7.96 | 78.6 | 96.8 | 53 |
| Coform | 50% PP | 70.2 | 0.486 | 94.8 | 5.32 | 67.8 | 80.5 | 33 |
| | 50% pulp | | | | | | | |
| KC | 50% PP | 73.5 | 0.95 | 96.1 | 3.73 | 80.8 | 85.3 | 67 |
| Huggies Coform | 50% pulp | | | | | | | |
| LBAL | 80% pulp | 59 | 0.72 | 95.5 | 3.05 | 67.8 | 84.8 | 60 |
| Airlaid | 20% binder | | | | | | | |
| Ultra | 70% pulp | 66 | 1.17 | 96.2 | −4.27 | 70.7 | 96.8 | 95 |
| White | 23% bico | | | | | | | |
| Wipe | 2% | | | | | | | |
| (Experimental bico fiber) | binder | | | | | | | |

The formula for the AOV is: AOV=20×((Opacity+Brightness+L*−b*)×Caliper (in mm)/basis weight (in gsm)).

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

1. a multilayer ultra white nonwoven wipe material comprising
(A)cellulose pulp having a whiteness greater than about 90;
(B)bicomponent fibers; and
(C) latex binder;
wherein the bicomponent fibers comprise a core comprising polyester, a sheath comprising polyethylene, an optical brightener, and a delustrant;
and wherein the latex binder is applied to the outer layers; and wherein
the wipe has an AOV greater than or equal to about 75.

2. The material of claim 1, wherein the material has a brightness of about 80 or greater.

3. The material of claim 1, wherein the material has an opacity of about 55 percent or greater.

4. The material of claim 1, wherein the cellulose pulp is a natural fiber, a synthetic fiber or a mixture thereof.

5. The material of claim 1, wherein the pulp is one or more cellulose pulp fibers, one or more synthetic fibers, or a mixture thereof.

6. The material of claim 1, wherein the pulp has a brightness of about 85 or greater.

7. The material of claim 1, wherein the bicomponent fiber contains a delustrant.

8. The material of claim 1, wherein the delustrant is titanium dioxide.

9. The material of claim 1, wherein the bicomponent fiber contains an optical brightener.

10. The material of claim 1, wherein the delustrant is in the sheath of the bicomponent fiber.

11. The material of claim 1, wherein the delustrant is in the core of the bicomponent fiber.

12. The material of claim 1, wherein the optical brightener is in the sheath of the bicomponent fiber.

13. The material of claim 1, wherein the optical brightener is in the core of the bicomponent fiber.

14. The material of claim 1, wherein the optical brightener is a bis(benzoxazolyl) stilbene.

15. The material of claim 1 further comprising two or more distinct strata where the composition of any one stratum is different from at least one adjacent stratum.

16. The material of claim 15, wherein the material has two outer strata and one or more inner strata and the bulk fiber of the two outer strata has a brightness of about 85 or greater.

17. The material of claim 15, wherein the material has two outer strata and one or more inner strata and the weight percent bicomponent fiber of the inner stratum or strata is greater than the weight percent bicomponent fiber in the outer strata.

18. The material of claim 1, wherein the material has been produced by an airlaid process.

19. The material of claim 1 in the form of a wipe, mop, diaper, feminine hygiene product, incontinent device or surgical drape.

20. An ultra white nonwoven wipe material having a basis weight of from about 40 gsm to about 100 gsm and a density of from about 0.03 to about 0.15 g/cc comprising:
(A)from about 57 to about 90 weight percent of a bulk fiber,
(B)optionally, from about 1 to about 8 weight percent of an emulsion polymer binder, and
(C)from about 5 to about 35 weight percent bicomponent fiber, and where the material has an AOV of about 75 or greater.

21. An ultra white nonwoven material having a basis weight of from about 25 gsm to about 250 gsm and a density of from about 0.03 to about 0.15 g/cc comprising:
(A)from about 57 to about 90 weight percent of a bulk fiber,
(B)optionally, from about 1 to about 8 weight percent of an emulsion polymer binder, and
(C)from about 5 to about 35 weight percent bicomponent fiber where the material has an AOV of about 75 or greater.

22. The material of claim 20 or claim 21, wherein the material has a brightness of about 80 or greater.

23. The material of claim 22, wherein the material has an opacity of about 55 percent or greater.

24. The material of claim 22, wherein the bulk fiber is a natural fiber, a synthetic fiber or a mixture thereof.

25. The material of claim 22, wherein the bulk fiber is one or more cellulose pulp fibers, one or more synthetic fibers, or a mixture thereof.

26. The material of claim 22, wherein the bulk fiber has a brightness of about 85 or greater.

27. The material of claim 22, wherein the bicomponent fiber contains a delustrant.

28. The material of claim 22, wherein the delustrant is titanium dioxide.

29. The material of claim 22, wherein the bicomponent fiber contains an optical brightener.

30. The material of claim 22, wherein the delustrant is in the sheath of the bicomponent fiber.

31. The material of claim 22, wherein the delustrant is in the core of the bicomponent fiber.

32. The material of claim 22, wherein the optical brightener is in the sheath of the bicomponent fiber.

33. The material of claim 22, wherein the optical brightener is in the core of the bicomponent fiber.

34. The material of claim 22, wherein the optical brightener is a bis(benzoxazolyl) stilbene.

35. The material of claim 22, wherein the material has two or more distinct strata where the composition of any one stratum is different from at least one adjacent stratum.

36. The material of claim 35, wherein the material has two outer strata and one or more inner strata and the bulk fiber of the two outer strata has a brightness of about 85 or greater.

37. The material of claim 35, wherein the material has two outer strata and one or more inner strata and the weight percent bicomponent fiber of the inner stratum or strata is greater than the weight percent bicomponent fiber in the outer strata.

38. The material of claim 22, wherein the material has been produced by an airlaid process.

39. The material of claim 22 in the form of a wipe, mop, diaper, feminine hygiene product, incontinent device or surgical drape.

40. The material of claim 1, 2, or 22, wherein the material has an aesthetic optical value of about 75 or greater.

41. A process for the production of a wipe material of claim 20 or a nonwoven material of claim 21 comprising airlaying from about 57 to about 90 weight percent of a bulk fiber, and from about 5 to about 35 weight percent bicomponent fiber to form material with one or more strata and where the material has a whiteness L of about 90 or greater.

42. A bicomponent fiber comprising: a core comprising polyester;
a sheath comprising polyethylene, an optical brightener in an amount of from about 100 to about 400 ppm by weight of the sheath, and a delustrant in an amount of from about 0.2 percent by weight to about 0.4 percent by weight of the sheath component.

43. The bicomponent fiber of claim 42, wherein the optical brightener is a bis(benzoazolyl) stilbene and the delustrant is titanium dioxide.

44. The bicomponent fiber of claim 42 or 43, wherein the fiber has a brightness of about 98 or greater.

45. The bicomponent fiber of claim 42, wherein the fiber has a whiteness value (L*) of about 90 or greater, a redness/greenness value (a*) of about 3.2 or greater, and a blueness/yellowness value (b*) of about −10 or less.
